(19) United States
(12) Patent Application Publication
(10) Pub. No.: US 2017/0282727 A1
(43) Pub. Date: Oct. 5, 2017

(54) Method and apparatus for optimizing the use of solar power in coordination with battery array buffered household solar energy collection systems

(71) Applicant: Jeremy Ellis, Norwalk, CA (US)

(72) Inventor: Jeremy Ellis, Norwalk, CA (US)

(21) Appl. No.: 15/530,865

(22) Filed: Mar. 10, 2017

Related U.S. Application Data
(60) Provisional application No. 62/390,421, filed on Mar. 29, 2016.

(51) Int. Cl. B60L 11/18; G04F 8/00; H02M 7/44; H02P 27/06; H02J 7/35; H02J 3/38

(52) U.S. Cl. CPC B60L 11/1809; H02J 7/35; H02J 3/383; H02M 7/44; H02P 27/06; G04F 8/00

(57) ABSTRACT

An adjustable timer useful to isolate a household solar array together with its power storage elements from the utility grid power connected to the household in order to fully accumulate the power stored in the storage elements that are then available for use at a time when the household occupants return to the household. One such use of the power thus stored may be to recharge an electric vehicle and other uses may include energy storage mechanisms utilizing compressed refrigerant.

### REFERENCE TO RELATED APPLICATIONS

The benefit of the earlier filing date of Mar. 29, 2016, of U.S. Provisional Application No. 62/390,421 is claimed for all matter common therewith.

### STATEMENT CONCERNING GOVERNMENT INTEREST

None.

### BACKGROUND OF THE INVENTION

### Field of the Invention

The present invention relates to a method and apparatus useful to provide high rate, utility grid isolated, solar generated vehicle recharging facility that concurrently disconnects the high current draw parts of a household from the utility grid during the recharging period thereby using only photovoltaic electric power for recharging.

### Description of the Prior Art

The development of the silicon crystal photovoltaic cell has reached substantial maturity, to a point where the simple addition of solar panels now provides easy choices to a home owner over the extent of their reliance on the local utility grid. Simply, direct conversion of solar irradiation into electrical power right on the roof of a typical home, particularly when buffered with battery arrays, provides choices that run opposite to the vested interests of an electric utility grid that rely on varying kilowatt-hour rates in each day to recover their earlier, now dated, capital investment, a coercion to discourage excessive use to extend the amortization interval a currently inadequate system. While originally effective, this use of varying power billing tiers in a twenty four hour cycle has now turned into a vestigial fact of life that, by its burden, provides a transitional driver compelling by its inconvenience the selection preference for those alternate energy developments that provide some independence from the same public utility grid.

Of course, other mismatches appear constantly on the horizon like those driven by current environmental concerns that compel the obvious preference for recharging of electric or hybrid powered personal vehicles right from an outlet at one's home. The currently evolving options of the nascent electric car technology also rests on the unfettered independence an electrically powered personal vehicle provides, a characteristic currently limited by a lagging battery technology development that is only further exacerbated by the current varying rate schedules that effectively limit recharging at home to overnight recharging. Moreover the same concerns over our environment provides its own compulsion for alternatives to a grid interlocked arrangement since it persists mainly for its usefulness as an energy provider to large industrial consumers. The promotion of renewable, or ‘green energy’ use that is simply inapposite in a regimen of scheduled time apertures imposed to preserve the remaining mostly fossil fuel driven technology that because of its age also exacerbates the risk of widespread grid failure.

All the foregoing considerations, along with the progression from hybrid vehicles, with their minimal battery capacities of 1 to 3 kilowatt hours, to electric only vehicles that carry battery banks now storing at least 15 to 30 kilowatt hours, dictate a concurrent progression in roof top generating capacity from the 4 to 5 kilowatts to compensate for the added daily kilowatt-hours consumed by the vehicle with ‘green energy’ that can be returned to the grid, together with further capacity padding dictated by, good design practices' that cover energy shortfalls due to weather, solar exposure angles and the like. The same basic notions of conservation also demand some buffering of any short term mismatch between the electric energy available from the roof-borne array which is usually best effected by batteries. Thus the same logic that compels a household to invest in a hybrid or electric vehicle also demands sufficient added solar collector reserve to accommodate its added energy consumption which may then be made available to be returned to the grid to compensate for any mismatches in timing.

What remains is the incongruity between the competing interests of a disparate economic pattern in the consuming public, with its poorest now served by a slowly decaying utility grid and the benefits of technological progress confined to the wealthier group, an incongruity that is not susceptible of any analytic resolution and must therefore be solved on a one-by-one individual basis. This compulsion is then further exacerbated because even the thermodynamic modeling of each household is distinctly unique and cannot be easily grouped, precluding all ‘standardized’ solutions that can be analytically used, further compelling one-by-one solutions that precludes any coherent grouping. An arrangement that conveniently accommodates these disparate demands by decoupling that portion of the grid that is not essential from the household and also from the solar array during vehicle recharging is extensively desired and it is one such arrangement that is disclosed herein. Significantly, this same arrangement may also be conformed for shared use by the neighbors of the homeowner either by an signaling light or by an internet message that the recharging facility is available for sharing.

### SUMMARY OF THE INVENTION

Accordingly it is the general purpose and object of the present invention to provide an electro-mechanical timing arrangement for isolating a solar panel array from a utility grid while the solar array is connected to a recharging station.

Other and further purposes and objects of the present invention shall become apparent from the teachings that follow when examined in conjunction with the illustrations appended.

Briefly, these and other objects are accomplished within the present invention by providing a roof top mounted solar array comprising solar panels interconnected to generate d.c. electric power at one of the higher potentials like 36 or 48 volts when illuminated by sunlight. By preferred practice this solar array is aligned to face generally southwardly at an inclination from vertical generally corresponding to the local latitude in order to optimize the local sunlight irradiation thereon through the course a day which is then combined and converted into direct current electrical power at the ends of a pair of electrical leads extending from the array and ending at the output terminals of a relay. These output terminals are switched to conduct by a control signal produced by the rotary passage of an adjustable timer ON terminal selectively secured to the edge of a first electrically driven rotary disc coaxially mounted to rotate in synchronism with a second disc that is also provided with a peripherally adjustable ON switching terminal connected to toggle yet another relay having its output terminals each connected to a that portion of the household circuitry that powers the heavy consumption items like a pool motor or the central air conditioning system of the household.

In this form a simple rotary timer is useful to set the leading and lagging low power consumption level intervals on either side of, or before and after, the high rate charging time aperture, to gradually lower the temperature differentials across the household walls that exponentially exacerbate thermal loss rates, the adjustments of the charging aperture also then attenuating any battery charge state deficits right when the charging occurs. An expensive and very complex thermodynamic modeling process is thus avoided in a setting where each location differs from others in a myriad of ways.

The foregoing concentrically aligned set of relay switching points therefore provide the learning convenience of adjusting the low load periods of operation on either side of the time aperture within which high rate recharging occurs, thereby providing an adjustment process in which the particular thermal inertias and heat transfer patterns can be learned by experience and then marked off on the respective disks. Of course, once thus adjusted the availability of a local quick charge can be announced either by an announcement light or by way of the Internet, to help defray the initial costs of the needed solar collection capacity that is needed for higher level charging rates.

This inherent simplicity and familiar form of the instant timing mechanism is particularly appropriate at the current developmental levels of our renewable energy technology. For example, as the electric vehicle development progresses towards its eventual maturity it also drives with it a compelling search for conveniently light weight storage mechanisms of the associated ‘green energy’ increase that this maturing process will bring and since there is no free lunch trade-offs and adjustments are inherent. A recent example of one such trade-off is a process proposed under the heading “SOLAR AIR CONDITIONING” published on Aug. 8, 2014, with an associated designation “RGS 5081”, URL designation www.youtube/watchRVZqTYGLoPSGec In this example a set accumulators is proposed into which the compressed refrigerant from a compressor is accumulated during the time when it is not needed to be later used when the household members return from work. Thus as we are leaving the centuries old fossil fuel based energy processes in favor of renewable energy this changeover itself introduces further combinations and permutations that are best resolved on an individual basis in the simple control mechanism described herein and the larger energy storage capacities of compressed gas are harnessed by accumulation of the output of a relatively small compression process that can be realistically accommodated within a household sized solar array.

### BRIEF DESCRIPTION OF THE DRAWINGS

FIG. 1 is a diagrammatic illustration of a typical residential dwelling provided with a roof mounted solar array that is useful to generate electrical power to complement the power also provided to the residential dwelling by a public utility grid or to serve as the power source to a high rate charging station for recharging electrically powered vehicles in accordance with the present invention;

FIG. 2 is a perspective illustration of an inventive multifunction rotary switch assembly useful to regulate the timing apertures during which the main load carrying circuit branches within the dwelling are disconnected from the utility grid while the solar array, buffered by a bank of storage batteries, is connected to power a high rate vehicle charging assembly to which an electrically powered vehicle may be connected for recharging, or which then announces that such a connection is available to others;

FIG. 3 is a diagrammatic illustration of a typical household electric power system including a solar array to augment the power supplied by a utility grid that is selectively interconnected to charge an electrically powered vehicle in accordance with the present invention;

FIG. 4 is a timing chart illustrating the timing apertures of the charging and off-grid intervals in accordance with the present invention; and

FIG. 5 is yet another diagrammatic illustration of a household electric power system including a utility grid augmented by a solar array and interconnected in accordance with the present invention to sequentially charge a plurality of compressed refrigerant accumulators.

### DESCRIPTION OF THE PREFERRED EMBODIMENTS

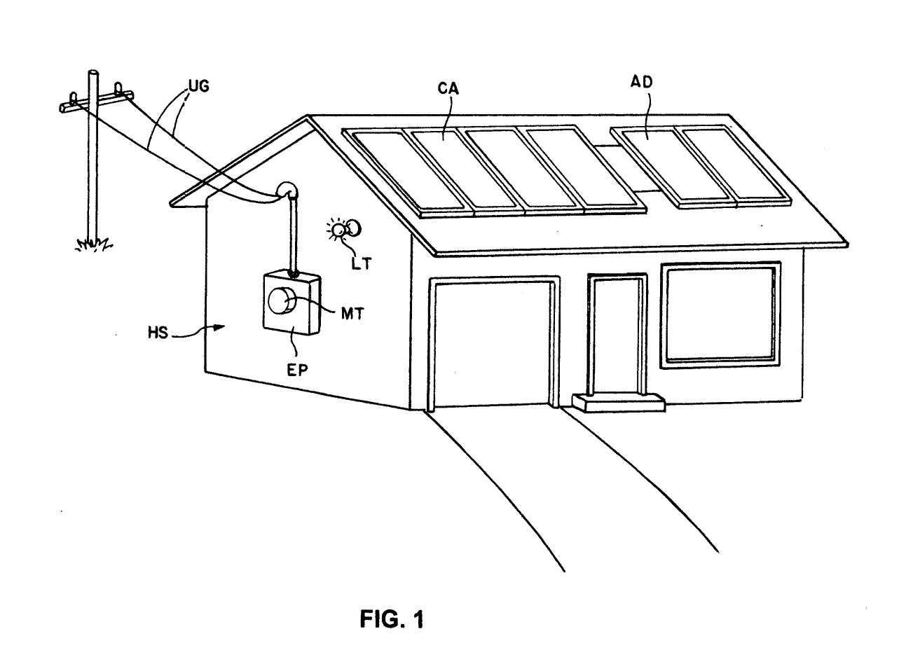

As shown in FIG. 1 our typical household structure HS now going through a solar energy revolution is characterized, when solar exposure is possible, by a rooftop mounted solar collector array generally designated CA connected at its output both to a set of charge controllers CC-1 through CC-m maintaining the charge state of a plurality of storage batteries SB-1 through SB-n and to the input of one or more power converting devices IN conformed like the inverter sold under the model designation XANTREX XW4024 Hybrid Inverter by WHOLESALE SOLAR, 412 N. Mount Shasta Rd., Mount Shasta, Calif. 96067, or a similar inverter capable of substantial alternating electrical power generation both in an electrical grid power referenced ‘grid tie or tied’ configuration or in a self-referenced, known as ‘OFF-Grid’ mode. Customarily inverters of this power capacity are operative both at 110 volts a.c. and also at the higher 240 volt levels that are similar to the power levels customarily delivered to the electric panel EP of the household structure HS by the public utility grid UG, with the power use (or net gain) then charged to the household by the grid provider at the rates set in a meter MT monitoring the grid power supplied and/or the excess power returned to the grid. In this form the electrical power generated by the collector array CA can be used to offset or supplement the power consumed by a household, or to add any excess to the power available in the grid to be shared with others, reducing the periodic load peaks that until now have driven the punitive power rate schedules, or to power the more critical power requirements in a household at those times when the grid fails.

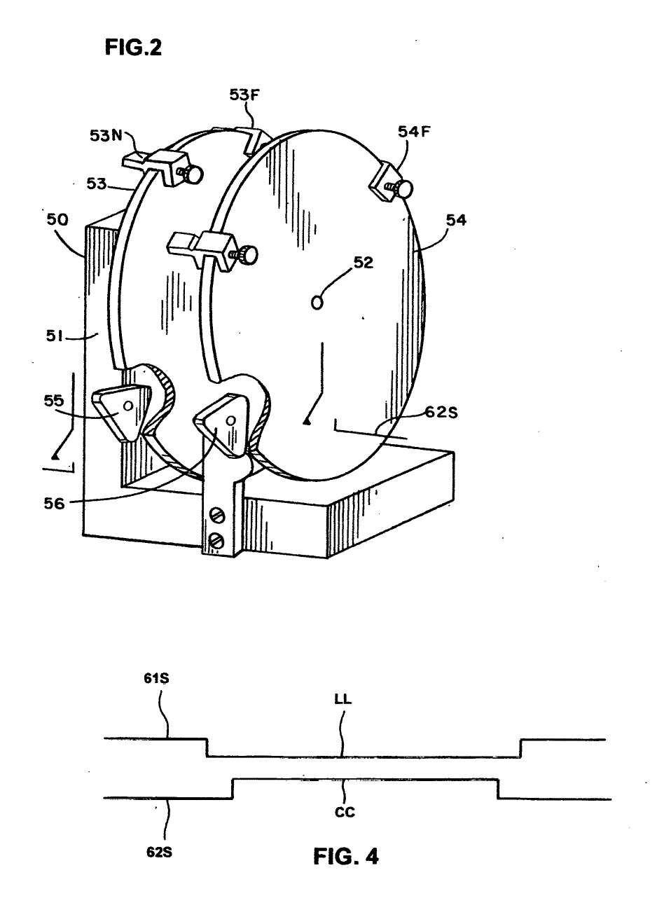

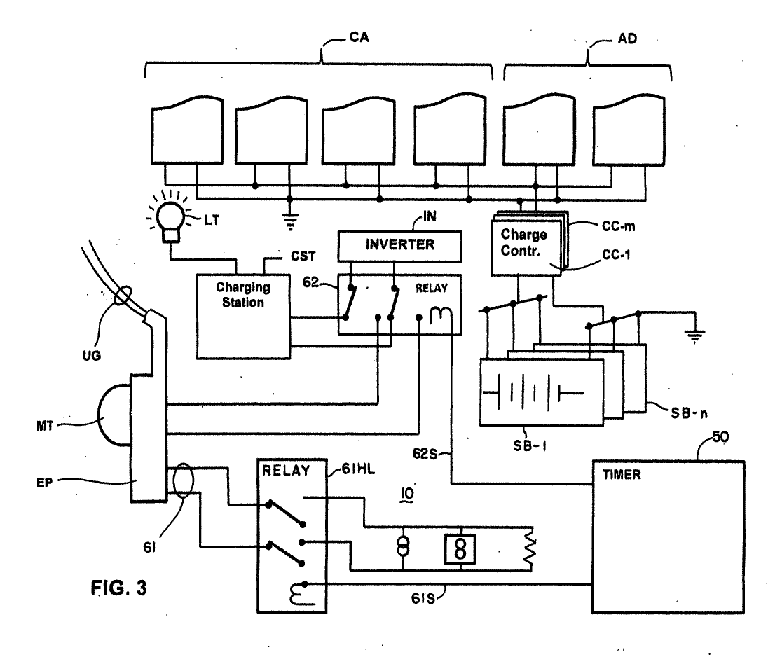

By particular reference to FIGS. 1, 2 and 3, this increasingly adopted broad flexibility of a photovoltaic power supplementing array has now become a technology driver, bringing on stream other green energy uses, like hybrid or fully electric powered vehicles, since its easy expansion makes fuel cost savings a well understood and easily computed cost justification. Simply, a conveniently connected additional collector AD is tied to the original array CA in an arrangement generally designated by the numeral 10 which is either interconnected to complement the power received from the utility grid UG or as an independent power source for a household charging station. An easily adjustable rotary timer assembly, generally designated by the numeral 50, then provides the household owner the convenience of adapting these switchover points to the uniquely particular use, thermal mass, heat transfer and solar exposure of the household with its individual economics and any at-home recharging patterns of the eventually acquired electric vehicle that may best serve the occupants of the house.

This easily effected convenience of adjusting the switching times, and also the description of the operative elements of the timer assembly 50 are both best achieved by reference to the very widely used pool pump timer manufactured by Intermatic, Inc., Spring Grove, Ill. 60081, under Model No. T101, that is sold in virtually all the hardware and pool supply outlets throughout the United States. Each such timer is characterized by an alternating current motor that drives in rotation a splined shaft on which a coaxial disc is mounted with the periphery of the disc carrying by a thumbscrew attachment an ON actuator and an OFF actuator that respectively extend to toggle a switch on and off, to turn the pool motor on and off The splined engagement of the shaft is spring loaded to adjust for daylight cycles while the thumbscrews allow adjustment between the on and off states.

The foregoing operative description of this well known device applies also to the structure and operation of the inventive switch assembly 50 and for that reason the details of a.c. drive motor and its engagement with the spring-loaded splined shaft are generally indicated by way of the bounding area 51, explanatory reference for these details being invited to the installation and use instructions offered by the manufacturer Intermatic, Inc. The extending part of the shaft, designated by the numeral 52, is then provided with two axially spaced concentric discs 53 and 54 each engaged by thumbscrew engagement to the on and off actuating projections 53N and 53F on disc 53 and 54N and 54F on disc 54. These projections that then toggle switches 55 and 56 to relay as follows.

More precisely, the switching arrangement set out herein seeks to smooth out the day to day use variation impact of the varying kilowatt-hour charges by the utility grid and for these reasons the household electrical circuit 61 that extends from panel EP is divided herein into the heavy current draw portion completed through a heavy load relay 61HL (or a plurality of relays in parallel) switched in and out of conduction by a switching signal 61S from toggle switch 55. Toggle switch 56, in turn, produces a relay signal 62S that switches in an out of conduction a relay 62 connected between the output of the inverter IN and a charging station CST which may also include a signaling light SL on the house exterior to allow a neighbor charge his or her car.

Those skilled in the art will appreciate that the foregoing arrangement allows for a convenient adjustment of the low total load period before and after each charging cycle so that the storage batteries SB1 through SBn can be selected to be recharged primarily by the solar array as illustrated by the timing signals CC defining the charging interval and LL the low load interval in FIG. 4, with the timing interval CC also turning on the signaling light LT that advises the homeowner (or the homeowner's neighbor) that the conditions are set for recharging. These adjustable leading and trailing gaps solve the very complex thermodynamic relationships that are inventively relegated to actual experience in a device that is easily used and implemented

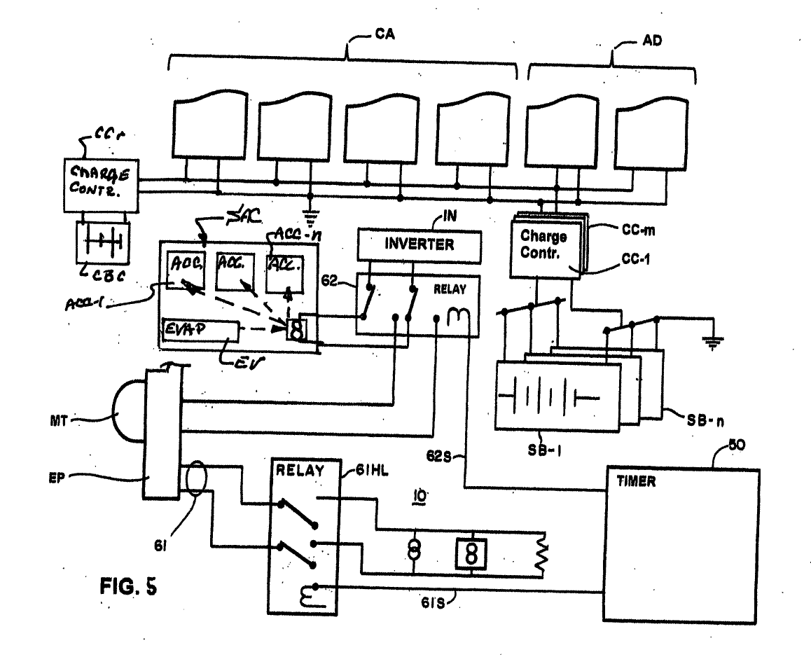

The convenience in accommodating the various demands of those occupying the household that this selective grid isolation provides also allows for a ready and quick adoption of other solar powered processes and systems that are coming on line, like the newly proposed use of solar power to charge up a plurality of compressed refrigerant accumulators exemplified above and illustrated in the inventive arrangement shown in FIG. 5. Like numbered parts functioning in the like manner as previously described the outputs of relay 62, in this instance, are connected to power the compressor CMP which then pressurizes the refrigeration fluid from evaporator EV of a solar air conditioner SAC and through a commutating arrangement stores the re-compressed refrigerant in a set of accumulators ACC-1 through ACC-n, to be used for cooling during the hot portion of the day. Since this period invariably occurs towards the end of the day, when the household residents return from work in their vehicles that were just fully charged during the trip home, these charged batteries CB-c can be then connected to increase the battery reserve. Of course, these may then be recharged during the low rate over-night period for the next day's trip. In this manner a simple rotary switch arrangement renders the evolving process of a continuously expanding array of green energy devices fully adaptable.

Obviously many modifications and variations of the instant invention can be effected without departing from the spirit of the teachings herein. It is therefore intended that the scope of the invention be determined solely by the claims appended hereto.

1. An adjustable timer assembly useful to switch the connections of a household solar array to energize for a preselected period an electrical function separately from the other electric loads of said household that may be powered by a utility grid, comprising:
an electrically powered rotary drive connected for electrical excitation to said utility grid for driving in rotation an axial shaft at a rotary rate corresponding to the alternating frequency of said utility grid;
a first and a second circular disc each coaxially fixed in spaced separation on said axial shaft for common rotation therewith;
energy storage means included in said electrical function for accumulating the energy produced by said solar array;
a first set of switch toggling projections adjustably engaged to the periphery of said first circular disc in an alignment to toggle a first switch; and
a second set of switch toggling projections adjustably engaged to the periphery of said second circular disc in an alignment to toggle a second switch.

2. An adjustable timer assembly according to claim 1, wherein:
said first switch is connected in a circuit including said energy storage means.

3. An adjustable timer assembly according to claim 2, wherein:
said second switch is connected in a circuit including said electrical function.

4. An adjustable timer assembly according to claim 1, wherein:
each said first and second switch toggling projections includes a thumb screw useful for the selective manual securement to the corresponding peripheries of the corresponding one of said first or second disc

5. An adjustable timer assembly according to claim 4, wherein:
said first switch is connected in a circuit including said energy storage means.

6. An adjustable timer assembly according to claim 5, wherein:
said second switch is connected in a circuit including said electrical function.

7. An adjustable timer assembly according to claim 6, wherein:
said electrical function includes an electrical car charging station.
